(19) United States
(12) Patent Application Publication
(10) Pub. No.: US 2022/0076077 A1
(43) Pub. Date: Mar. 10, 2022

(54) QUALITY ESTIMATION MODEL TRAINED ON TRAINING SIGNALS EXHIBITING DIVERSE IMPAIRMENTS

(71) Applicant: Microsoft Technology Licensing, LLC, Redmond, WA (US)

(72) Inventors: Chandan Karadagur Ananda REDDY, Redmond, WA (US); Vishak GOPAL, Redmond, WA (US); Ross Garrett CUTLER, Clyde Hill, WA (US)

(73) Assignee: Microsoft Technology Licensing, LLC, Redmond, WA (US)

(21) Appl. No.: 17/062,308

(22) Filed: Oct. 2, 2020

Related U.S. Application Data
(60) Provisional application No. 63/074,880, filed on Sep. 4, 2020.

(51) Int. Cl. G06K 9/62; G06N 3/08; G06N 20/00

(52) U.S. Cl. CPC G06K 9/6262; G06K 9/6227; G06N 20/00; G06N 3/084; G06K 9/6256

(57) ABSTRACT

This document relates to training and employing a quality estimation model. One example includes a method or technique that can be performed on a computing device. The method or technique can include obtaining training signals exhibiting diverse impairments introduced when the training signals are captured or diverse artifacts introduced by different processing characteristics of a plurality of data enhancement models. The method or technique can also include obtaining quality labels for the training signals, and training a quality estimation model to estimate signal quality based at least on the training signals and the quality labels.

### BACKGROUND

Machine learning can be used to perform a broad range of tasks, such as natural language processing, financial analysis, and image processing. Machine learning models can be trained using several approaches, such as supervised learning, semi-supervised learning, unsupervised learning, reinforcement learning, etc. In approaches such as supervised or semi-supervised learning, labeled training examples can be used to train a model to map inputs to outputs. In unsupervised learning, models can learn from patterns present in an unlabeled dataset.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for training and employing a quality estimation model. One example includes a method or technique that can be performed on a computing device. The method or technique can include obtaining training signals exhibiting diverse impairments introduced when the training signals are captured or diverse artifacts introduced by different processing characteristics of a plurality of data enhancement models. The method or technique can also include obtaining quality labels for the training signals. The method or technique can also include training a quality estimation model to estimate signal quality based at least on the training signals and the quality labels.

Another example includes a system having a hardware processing unit and a storage resource storing computer-readable instructions. When executed by the hardware processing unit, the computer-readable instructions can cause the system to access a quality estimation model that has been trained to estimate signal quality using training signals exhibiting diverse impairments introduced when the training signals were captured or diverse artifacts introduced by a plurality of data enhancement models. The computer-readable instructions can also cause the system to provide an input signal to the quality estimation model. The computer-readable instructions can also cause the system to process the input signal with the quality estimation model to obtain a synthetic quality label for the input signal.

Another example includes a computer-readable storage medium. The computer-readable storage medium can store instructions which, when executed by a computing device, cause the computing device to perform acts. The acts can include obtaining training signals exhibiting at least one of diverse impairments introduced when the training signals are captured or diverse artifacts introduced by different processing characteristics of a plurality of data enhancement models. The acts can also include obtaining quality labels for the training signals. The acts can also include training a quality estimation model to estimate signal quality based at least on the training signals and the quality labels.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example system, consistent with some implementations of the present concepts.

FIG. 2 illustrates an example method or technique for training and employing a quality estimation model, consistent with some implementations of the present concepts.

FIG. 3 illustrates an example individual quality estimation model, consistent with some implementations of the disclosed techniques.

FIG. 4 illustrates an example overall quality estimation model, consistent with some implementations of the present concepts.

FIG. 5 illustrates an example workflow for training an individual quality estimation model, consistent with some implementations of the present concepts.

FIG. 6 illustrates an example initial data enhancement model, consistent with some implementations of the disclosed techniques.

FIG. 7 illustrates an example modified data enhancement model, consistent with some implementations of the disclosed techniques.

FIG. 8 illustrates an example workflow for modifying a data enhancement model, consistent with some implementations of the present concepts.

FIG. 9 illustrates an example user experience and user interface, consistent with some implementations of the present concepts.

### DETAILED DESCRIPTION

### Overview

The disclosed implementations generally offer techniques for producing quality estimation models that can be employed to estimate the quality of input signals. For instance, the input signal can be an audio, image, video, or other signal that has been digitally sampled. As discussed more below, once a suitable quality estimation model is obtained, the quality estimation model can be used for various purposes such as automated estimation of signal quality or producing synthetic quality labels for training of data enhancement models, such as noise suppressors, image sharpeners, etc.

### Definitions

For the purposes of this document, the term “signal” refers to a function that varies over time or space. A signal can be represented digitally using data samples, such as audio samples, video samples, or one or more pixels of an image. A “data enhancement model” refers to a model that processes data samples from an input signal to enhance the perceived quality of the signal. For instance, a data enhancement model could remove noise or echoes from audio data, or could sharpen image or video data. The term “quality estimation model” refers to a model that evaluates an input signal to estimate how a human might rate the perceived quality of the signal. For example, a quality estimation model could estimate the quality of an unprocessed or raw audio signal, and output a synthetic label characterizing the quality of the signal with respect to impairments such as device distortion, background noise, and/or room reverberation. A quality estimation model could also evaluate a processed audio signal that has been output by a particular data enhancement model to remove noise from a noisy input signal, and the quality estimation model could output a synthetic label reflecting how effective the particular data enhancement model was at removing noise as well as the extent to which the particular data enhancement model may have introduced undesirable artifacts when removing the noise. Here, the term “synthetic label” means a label at least partially generated by a machine, where a “manual” label is provided by a human being.

The term “model” is used generally herein to refer to a range of processing techniques, and includes models trained using machine learning as well as hand-coded (e.g., heuristic-based) models. For instance, a machine-learning model could be a neural network, a support vector machine, a decision tree, etc. Whether machine-trained or not, data enhancement models can include codecs or other compression mechanisms, audio noise suppressors, echo removers, distortion removers, image/video healers, low light enhancers, image/video sharpeners, image/video denoisers, etc., as discussed more below.

The term “impairment,” as used herein, refers to any characteristic of a signal that reduces the perceived quality of that signal. Thus, for instance, an impairment can include noise or echoes that occur when recording an audio signal, or blur or low-light conditions for images or video. One type of impairment is an artifact, which can be introduced by a data enhancement model when removing impairments from a raw data sample. Viewed from one perspective, an artifact can be an impairment that is introduced by processing an input signal to remove other impairments. Another type of impairment is a recording device impairment introduced into a raw input signal by a recording device such a microphone or camera. Another type of impairment is a capture condition impairment introduced by conditions under which a raw input signal is captured, e.g., room reverberation for audio, low light conditions for image/video, etc.

### Machine Learning Overview

There are various types of machine learning frameworks that can be trained to perform a given task, such as estimating the quality of a signal or enhancing a signal. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned. Note that two trained models can share the same model structure and yet have different values for the internal parameters, e.g., if the two models are trained on different training data or if there are underlying stochastic processes in the training process.

### Technical Effect

As noted previously, machine learning can be employed for training data enhancement models to enhance input signals. For instance, a data enhancement model that enhances speech audio can be trained using labeled training data to improve the quality of input speech data by removing noise or other impairments from the input signal. One way to obtain labeled training data for a data enhancement model is to have human users review processed signals output by the data enhancement model and evaluate the quality of the processed signal, e.g., on a scale of 1-5.

However, manual labeling of training data does not scale well, e.g., it can be time-consuming, laborious, and expensive to obtain large-scale training data. One approach for mitigating this issue could be to use automated technologies, instead of human users, to label processed data. For instance, a quality estimation model that could accurately replicate the performance of a human user at labelling input signals could drastically reduce the costs associated with training data enhancement models.

However, there is no currently-available quality estimation model with sufficient accuracy to serve as an appropriate substitute for human labelers. Ideally, a quality estimation model would be both accurate and robust. Here, accuracy refers to the ability of the quality estimation model to replicate human performance on a given dataset, and robustness refers to the ability of the quality estimation model to retain consistent accuracy when exposed to new input signals that have different characteristics than those seen during training.

One issue complicating matters is that machine learning models can tend to overfit to a training dataset, and do not generalize well to unseen data. Thus, a quality estimation model trained on a single dataset may not perform well on other datasets. In other words, such a quality estimation model is not particularly robust.

To some extent, this issue arises in the data enhancement context because different enhancement techniques can tend to introduce different artifacts into enhanced data. Thus, a quality estimation model trained to recognize adverse effects of a first type of artifact produced by a first data enhancement model might not recognize other adverse effects from a second type of artifact produced by a second data enhancement model. In addition, recording device and capture condition impairments can also vary significantly. Thus, a quality estimation model trained to recognize impairments introduced by capturing raw input signals with specific recording devices or under specific conditions may not recognize other types of impairments introduced by other recording devices or recording conditions.

Another issue that has hampered the development of data enhancement models is that some approaches rely on access to an unimpaired reference signal. For instance, a lossy compression model could be evaluated by comparing the quality of the compressed signal to the raw, uncompressed signal. However, in many contexts, no unimpaired reference signals are available. For instance, a recording of a speaker in front of a live audience will tend to have significant amounts of noise and thus there is no unimpaired reference signal that can be used to train a noise removal model on such a recording, as the original recording itself has noise impairments.

The disclosed implementations aim to mitigate these issues by exposing a quality evaluation model to a diverse range of impairments present in training signals, where the impairments may be introduced when the training signals are captured and/or introduced as artifacts several or many different data enhancement models. As a consequence, a quality evaluation model trained on a dataset such as disclosed herein can learn to recognize a broad range of impairments in raw signals and/or artifacts introduced by various types of data enhancement models. Thus, such a quality evaluation model can generalize well to novel input data, such as processed signals produced by data enhancement models that were not used for initial training of the quality evaluation model or raw input signals obtained using different recording devices, or under different recording conditions, than those used to train the quality evaluation model.

Once a quality evaluation model has been trained in this manner, the quality evaluation model can serve as a substitute for human evaluation. Thus, for example, the quality evaluation model can be used to generate vast amounts of synthetic labels for raw or processed input signals without the involvement of a human user. Synthetic labels can be used to drastically increase the efficiency with which data enhancement models can be trained to reduce impairments in input signals.

### Example System

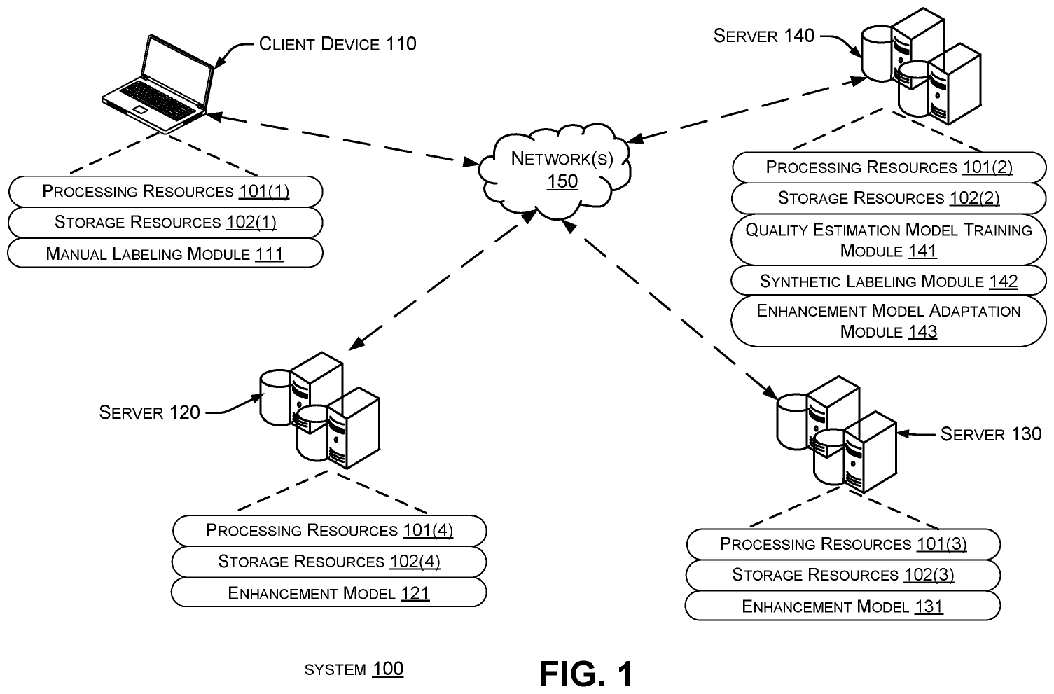

The present implementations can be performed in various scenarios on various devices. FIG. 1 shows an example system 100 in which the present implementations can be employed, as discussed more below.

As shown in FIG. 1, system 100 includes a client device 110, a server 120, a server 130, and a server 140, connected by one or more network(s) 150. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 1, but particularly the servers, can be implemented in data centers, server farms, etc.

Certain components of the devices shown in FIG. 1 may be referred to herein by parenthetical reference numbers. For the purposes of the following description, the parenthetical (1) indicates an occurrence of a given component on client device 110, (2) indicates an occurrence of a given component on server 120, (3) indicates an occurrence on server 130, and (4) indicates an occurrence on server 140. Unless identifying a specific instance of a given component, this document will refer generally to the components without the parenthetical.

Generally, the devices 110, 120, 130, and/or 140 may have respective processing resources 101 and storage resources 102, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 110 can include a manual labeling module 111 that can assist a human user in labeling training signals with manual quality labels. For instance, the training signals can include images, audio clips, video clips, etc. In some cases, the human users evaluate training signals produced by using data enhancement model 121 on server 120 and data enhancement model 131 on server 130 to enhance raw input signals. Thus, the manual quality labels provided by the user can generally characterize how effective the respective enhancement models are at enhancing the raw input signals. In other cases, the manual quality labels can characterize the quality of unprocessed (e.g., raw or unenhanced) training signals.

Quality estimation model training module 141 on server 140 can train a quality estimation model using the manual quality labels and the training signals. For instance, a quality estimation model can evaluate the training signals and output synthetic quality labels that convey the relative quality of the training signals, as estimated by the quality estimation model. The quality estimation model training module can modify internal parameters of the quality estimation model based on the difference between the manual quality labels provided by the human users and the synthetic quality labels output by the quality estimation model. For instance, in neural network implementations, a loss function can be defined to calculate a loss value that is propagated through one or more layers of the quality estimation model. The loss function can be proportional to the difference between the synthetic quality labels output by the quality estimation model and the manual quality labels.

Once the quality estimation model is trained, synthetic labeling module 142 can label input signals with synthetic labels using the trained quality estimation model. For instance, a training corpus can be generated by processing a large number of unlabeled input signals using the quality estimation model. In other cases, the synthetic labeling module can be used to label input signals for other purposes, such as real-time feedback on audio or video quality of a call.

Enhancement model adaptation module 143 can use the synthetic labels provided by synthetic labeling module 142 to train or otherwise modify a new data enhancement model. For instance, for a neural network-based data enhancement model, the enhancement model adaptation module can adjust internal model parameters such as weights or bias values, or can adjust hyperparameters, such as learning rates, the number of hidden nodes/layers, momentum values, batch sizes, number of training epochs/iterations, etc. The enhancement model adaptation model can also modify the architecture of such a model, e.g., by adding or removing individual layers, densely vs. sparsely connecting individual layers, adding or removing skip connections across layers, etc.

### Example Method

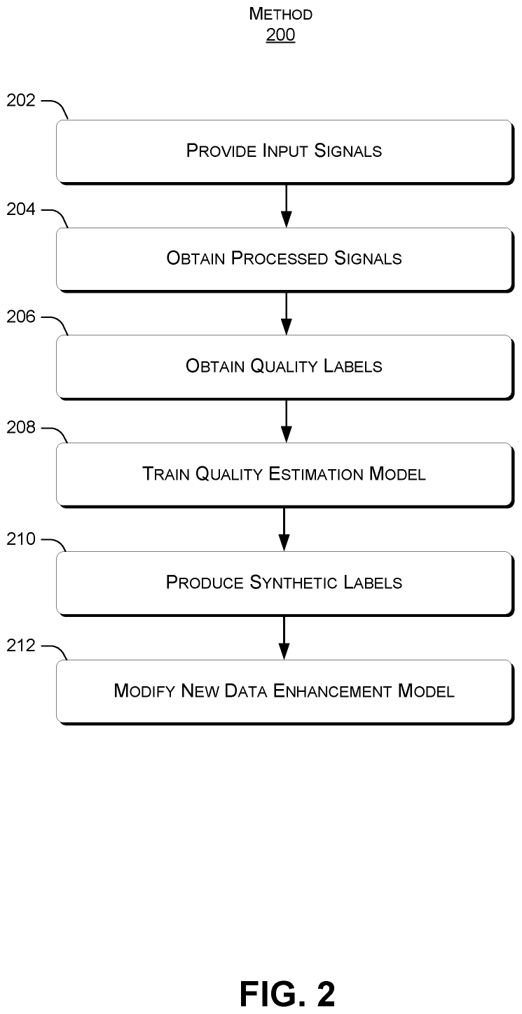

FIG. 2 illustrates an example method 200, consistent with some implementations of the present concepts. Method 200 can be implemented on many different types of devices, e.g., by one or more cloud servers, by a client device such as a laptop, tablet, or smartphone, or by combinations of one or more servers, client devices, etc.

Method 200 begins at block 202, where input signals are provided to a plurality of data enhancement models having different processing characteristics. As noted, the input signals can include raw or unenhanced images, audio clips, video clips, etc.

Method 200 continues at block 204, where processed signals are obtained. The processed signals can be output by the data enhancement models, and can exhibit diverse artifacts introduced by the different processing characteristics of the data enhancement models. For instance, the processed signals can include digitally-enhanced or compressed images, video clips, or audio clips.

Method 200 continues at block 206, where quality labels are obtained for training signals, where the training signals can include the input signals and/or the processed signals obtained at block 204. For instance, the quality labels can be provided via manual evaluation of the training signals. For processed signals, the quality labels characterize quality of the processed signals without reference to the input signals (e.g., on a scale of 1 to 5). In other cases, the quality labels characterize the extent to which the processed signals are enhanced relative to the input signals, e.g., if the original signal is rated by a user has having a quality of 1 and the processed signal is rated by the user as having a quality of 3, the quality label indicates an improvement of two points.

Method 200 continues at block 208, where a quality estimation model is trained to estimate signal quality using the training signals and the quality labels. As noted elsewhere herein, a quality estimation model can be provided using various machine learning approaches including, but not limited to, convolutional deep neural networks.

Method 200 continues at block 210, where synthetic quality labels are produced for other input signals using the trained quality estimation model. For instance, the other input signals can be processed signals output by a new data enhancement model, where “new” means that the new data enhancement model was not used to train the quality estimation model in block 208 of method 200. The other input signals can also include raw or unenhanced signals.

Method 200 continues at block 212, where the new data enhancement model is modified. For instance, the synthetic labels can be used to evaluate processed signals output by the new data enhancement model. Internal parameters, hyperparameters, and/or an architecture of the new data enhancement model can be modified based on the synthetic labels.

Blocks 202, 204, 206, and 208 of method 200 can be performed by quality estimation model training module 141. Block 210 of method 200 can be performed by synthetic labeling module 142. Block 212 of method 200 can be performed by enhancement model adaptation module 143.

### Quality Estimation Model Details

In some implementations, the input signals provided to the data enhancement models at block 202 include raw (e.g., unenhanced) images, audio clips, or video clips. For audio clips, the data enhancement models can include any of noise removal models, echo removal models, distortion removal models, codecs, or models for addressing quality degradation caused by room response, or network loss/jitter issues. For images or video clips, the data enhancement models can include any of image/video healing models, low light enhancement models, image/video sharpening models, image/video denoising models, codecs, or models for addressing quality degradation caused by color balance issues, veiling glare issues, low contrast issues, flickering issues, low dynamic range issues, camera jitter issues, frame drop issues, frame jitter issues, and/or audio video synchronization issues.

In some implementations, quality estimation models and/or data enhancement models can be provided as machine learning models, such as deep neural networks. Quality estimation models can be used to produce synthetic labels for training examples that can then be used to modify other data enhancement models. For instance, as noted previously, internal parameters, hyperparameters, and/or architectures of data enhancement models can be adjusted using the synthetic labels. A quality estimation model can also be used to rank data enhancement models relative to one another, e.g., based on the average value of synthetic labels produced by the quality estimation model when evaluating processed signals output by multiple data enhancement models on the same set of input signals.

As discussed more below, different quality estimation models can be provided to evaluate processed signals produced by different types of data enhancement models. For instance, one quality estimation model can be trained on processed signals produced by various noise suppression models, another quality estimation model can be trained on processed signals produced by various echo removal models, and so on. The outputs of these individual quality estimation models can be combined to produce an overall quality rating for a processed signal. In other implementations, an overall quality estimation model is provided with individual quality estimation models as constituent components of the overall quality estimation model. For instance, one more intermediate layers of a neural network may be trained to evaluate quality of processed signals that have undergone noise suppression, one or more other intermediate layers may be trained to evaluate quality of processed signals that have undergone evaluate echo cancellation processing, and so on. Such an overall quality estimation model may have another layer that combines values from these intermediate layers to provide a final, overall assessment of quality of a given processed signal, as discussed more below.

In some cases, the human labels and/or synthetic labels rate the quality of a given processed signal with reference to the input (e.g., raw) signals from which that processed signal was derived. In this case, the human and/or synthetic labels reflect the extent to which the enhancement improved the quality of the input signal. In other cases, the human and/or synthetic labels evaluate the processed signal without considering the input signal from which the processed signal is derived. In addition, a quality estimation model can be trained using the disclosed techniques without access to an unimpaired reference signal.

### Example Quality Estimation Model Structure

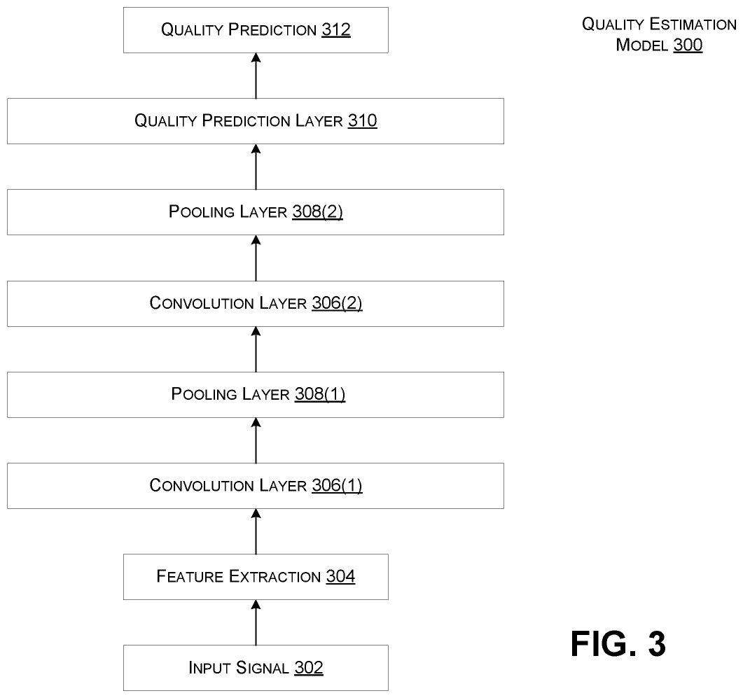

FIG. 3 illustrates an example structure of a quality estimation model 300, consistent with some implementations of the present concepts. The quality estimation model receives an input signal 302 that undergoes feature extraction 304. Extracted features are input to a convolution layer 306(1), which outputs values to a pooling layer 308(1). The output of pooling layer 308(1) is input to another convolution layer 306(2), which outputs values to another pooling layer 308(2). The output of pooling layer 308(2) is processed by a quality prediction layer 310, which produces a quality prediction 312.

In some cases, the quality prediction layer 310 can output a statistical distribution, e.g., a likelihood for one of a discrete number of quality options. For instance, the quality options can be binary, e.g., positive or negative, and the quality prediction 312 can be a statistical distribution such as a 70% likelihood of a positive quality or 30% likelihood of a negative quality for a given input signal. As another example, assuming a discrete set of five possible quality labels (e.g., from one to five stars), the quality prediction can be a statistical distribution such as a 10% likelihood of five stars, 80% likelihood of four stars, 10% likelihood of three stars, 8% likelihood of two stars, and 2% likelihood of one star. In other implementations, the output prediction can be a continuous value, e.g., a floating-point value such as 3.2 stars, 4.1 stars, etc.

As noted, a quality estimation model can be employed to evaluate the quality of audio clips. In such a case, feature extraction 304 can involve vectorization of a time domain waveform representing the audio clip. However, this results in a very large input dimension. In other implementations, spectral-based features such as log power spectrum and log power Mel spectrogram input features can be extracted from the audio clip. For Mel spectral features, some implementations use a frame size of 20 ms with hop length of 10 ms and 120 Mel frequency bands. The input features are then converted to dB scale during the feature extraction.

Note that quality estimation model 300 employs a convolutional neural network structure. Convolutional layers 306(1) and 306(2) are responsible for mapping, into their units, detected features from receptive fields in previous layers. This is referred to as a feature map and is the result of a weighted sum of the input features passed through a non-linearity such as a rectified linear unit or “ReLU.” Pooling layers 308(1) and 308(2) can take the maximum or average of a set of neighboring feature maps, reducing dimensionality by merging semantically similar features. Each convolutional layer can have a specified number of filters (e.g., 32, 64, etc.) applied to a specified window of input data (e.g., 3×3) for subsequent pooling (e.g., 2×2). A fully-connected layer can be employed used prior to the output unit. ReLU can be employed as an activation function within the hidden units and a learning rate of 0.0001.

Note that FIG. 3 is just one example of a quality estimation model structure. In other implementations, a multilayer perceptron (MLP) is adopted that maps the input features into a linearly separable feature space. This can be achieved by successive linear combinations of the input variables, zi=wixi+bi, where wi and bi are weights and biases, followed by a nonlinear activation function. For instance, one example model structure architecture has 400 input units, followed, respectively, by 200 and 100 units in the first and second hidden layers. Another example model receives a feature vector of size 1×1450 and has four fully connected layers with 1024 hidden units each.

Such neural network models can utilize a fixed length of the feature vectors, while the duration of the evaluated audio signal varies. This problem can be addressed either by computing statistics of the features before sending them to the neural network (e.g. i-vectors), or by feeding the neural network with a fixed length of extracted vectors multiple times until the audio file ends, while computing statistics across the timeline. The mean or the mode can be used, but it is also possible to employ an additional classifier, such as the extreme learning machine.

### Example Overall Quality Estimation Model

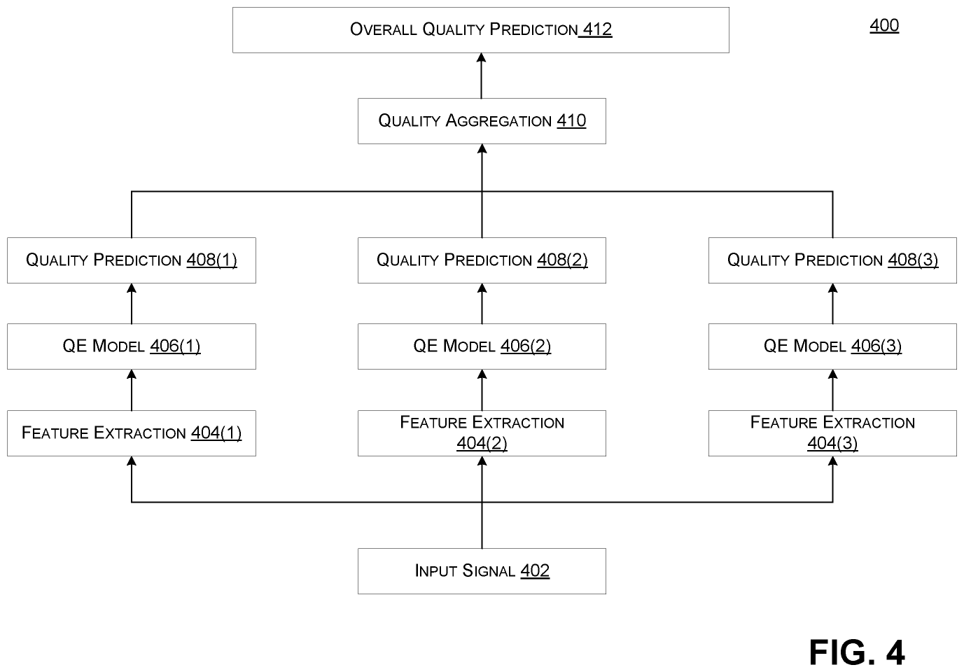

FIG. 4 illustrates an example structure of an overall quality estimation model 400, consistent with some implementations of the present concepts. The overall quality estimation model receives an input signal 402 and feeds the input signal into three feature extraction stages 404(1), 404(2), and 404(3). Note that the input signal can be a processed signal that was produced by a data enhancement model by processing another input signal. Thus, the term “input signal” as used herein is from the perspective of the model processing the signal.

Extracted features are input into three individual quality estimation models 406(1), 406(2), and 406(3). Each individual quality estimation model outputs a corresponding quality prediction 408(1), 408(2), and 408(3). The individual quality predictions 408(1), 408(2), and 408(3) are input to quality aggregation 410, which produces an overall quality prediction 412 representing the predicted overall quality for the input signal.

Each of the individual quality evaluation models 406(1), 406(2), and 406(3) can be trained to recognize artifacts introduced by different types of data enhancement models. For instance, in an audio context, quality estimation model 406(1) can be trained on processed signals produced by numerous noise removal models, quality estimation model 406(2) can be trained on processed signals produced by numerous echo removal models, and quality estimation model 406(3) can be trained on processed signals produced by numerous distortion removal models. Each individual quality estimation model can have a different structure. For instance, the noise removal model could be a convolutional neural network, the echo removal model could be a recurrent neural network, and the distortion removal model could be a convolutional neural network with a different structure than the noise removal model, e.g., different window sizes, fewer or more convolutional layers, etc. In addition, note that some implementations may employ individual quality estimation models trained to recognize recording device or capture condition impairments as described elsewhere herein.

Generally, quality aggregation 410 can involve employing a function that determines the relative contribution of each individual quality prediction to arrive at the overall quality prediction 412. In some cases, the aggregation can involve applying a linear or nonlinear function to weight each individual quality prediction. The function can be learned using machine learning or can be based on one or more heuristics. In some cases, the quality aggregation can be performed using one or more neural network layers that are trained separately from the individual quality estimation models. In other cases, one or more of the individual quality estimation models can be trained together with the quality aggregation layer(s).

To train overall quality estimation model 400, some implementations may employ manual quality labels for each individual quality evaluation model as well as overall manual quality labels. For instance, consider audio clips that have undergone noise removal, echo removal, and distortion removal to generate a third processed audio signal. In some cases, a human user can provide first manual quality labels for the audio signals after noise removal, second manual quality labels for the audio signals after echo removal, third manual quality labels for the audio signals after distortion removal, and fourth manual quality labels for final audio signals that have undergone all three enhancements. In this manner, the overall quality estimation model can be provided with training data that reflects the relative contribution of each type of enhancement to how human users perceive the overall quality of a given audio clip.

### Training Data Distributions

As previously noted, different data enhancement models can tend to produce processed signals that are perceived differently by human users. As a consequence, the manual quality labels provided for such processed signals can have varying underlying distributions. For instance, consider a noise removal model A with manual quality labels concentrated at the low end on a scale of 1-5, e.g., 80% of processed signals rated 2 or lower by human users. Another noise removal model B might have manual quality labels concentrated at both the low end and the high end of the scale, with relatively few manual quality labels falling in the middle of the scale, e.g., 80% of manual labels being either a 1 or a 5 and only 20% of labels between 2-4.

On the other hand, it is generally desirable to have a uniform distribution of quality labels for training a quality estimation model, because this exposes the quality estimation model to a wide range of signal quality during training. Thus, some implementations may sample processed signals output by each data enhancement model to achieve a relatively uniform distribution. Continuing with the previous examples, some implementations can sample training examples of processed signals output by noise removal models A and B so that the training set has a relatively uniform distribution.

In other words, since noise removal model A has manual quality labels concentrated at the low end of the rating scale, training examples from noise removal model A may be sparsely sampled from the low end of the rating scale and more heavily sampled toward the middle and upper ends of the scale to achieve a relatively more even distribution for training a quality estimation model. Likewise, since noise enhancement model B has manual quality labels concentrated at the low and high ends of the scale, training examples from noise removal model B might be sampled more heavily from the middle of the rating scale and more sparsely from the low and high ends of the rating scale to achieve a relatively more even distribution of training examples.

Referring back to FIG. 2, in some cases, block 204 of method 200 can involve sampling from manually-labeled training examples as described above to obtain a relatively uniform distribution of quality labels, as described above.

### Enhancement Model Selection Criteria

As noted, the disclosed implementations can expose a quality estimation model to a broad range of artifacts during training, as this generally improves robustness of the trained quality estimation model. On the other hand, sometimes different data enhancement models produce very similar artifacts. When many training examples are obtained with very similar artifacts, the training examples may be somewhat redundant and additional benefit may not be obtained from further training on redundant training examples. Furthermore, in some cases, a quality estimation model can be overfit to the training data set, particularly if a particular type of artifact is substantially overrepresented in the training data.

To address these issues, some implementations can use artifact classification to select particular data enhancement models to use for training the quality estimation model. For instance, audio data enhancement models can have processing characteristics that introduce phase distortion artifacts, compression artifacts, high frequency distortion artifacts, harmonic artifacts, etc. Thus, some implementations may ensure that each type of artifact is adequately represented in the training data set, e.g., by ensuring that a threshold number of data enhancement models that produce each type of artifact is used to obtain training data. For instance, some data enhancement models work only on the magnitude spectrum and thus generally do not introduce phase distortions, whereas data enhancement models that work either (a) in the magnitude and phase domains or (b) in time domain can introduce phase distortions. Thus, some implementations can preferentially select certain data enhancement models for training based on the domain that they work in, to ensure that data enhancement models that work in each domain are adequately represented in the training data for the quality estimation model. Referring back to FIG. 2, in some cases, block 204 of method 200 can involve automated or manual classification of individual data enhancement models for the types of artifacts that they produce, and selecting specific data enhancement models from a larger set of candidate data enhancement models for training a quality estimation model. The selection can be based on the classified artifacts, and can exclude data enhancement models that tend to produce artifacts that are already well-represented by the data enhancement models that have already been selected to train the quality estimation model.

Another mechanism for determining whether a given data enhancement model should be used for training involves determining whether performance of the quality estimation model improves when trained on training examples produced using that data enhancement model. One way to determine the extent, if any, to which training on a given data enhancement model improves the quality estimation model is to calculate the Pearson and/or Spearman correlation values between synthetic labels produced by the quality estimation model after training on that data enhancement model and manual quality labels. If the Pearson and/or Spearman correlation values between the synthetic and manual labels increase, then training examples produced by that data enhancement model can be added to the training set, and if not, those training examples can be discarded.

### Input Signal Selection

As discussed above, it is useful for a quality estimation model to be exposed to a broad range of artifacts during training. In addition, the quality estimation model can also benefit from being exposed to a training examples that exhibit a broad range of other characteristics besides artifacts introduced during enhancement. For instance, in the case of speech data, it can be useful to train on speech that is relatively equally distributed among speakers of both genders. Likewise, it can be useful to train on speech from speakers from a broad range of ages, to train on speech exhibiting different ways of conveying emotions (e.g., crying, yelling, singing, etc.), as well as on speech in different languages (e.g., tonal vs. non-tonal). By exposing a quality estimation model to such a broad range of signal characteristics during training, the quality estimation model may be robust when employed for speakers of different languages, ages, genders, and emotions.

In addition, it can be beneficial for the quality estimation model to train on different types of impairments. Thus, some implementations may start with raw input signals. Some of these raw input signals may be very high-quality, e.g., from a speaker recorded in a quiet room with a high-quality microphone, whereas others may have inherent speech distortion, background noise, and/or reverberations. Some implementations may sample from the clean signals based on criteria such as manual quality labels, e.g., by selecting the top quartile of raw speech signals to use for subsequent training.

Next, impairments can be selected to be introduced to the raw input signals. Impairments can often be classified into different classes. For instance, given a corpus of audio clips with examples of noise, some implementations can process the corpus to filter out any examples with speech. The remaining audio clips can include noises such as fans, air conditioners, typing, doors being shut, clatter noises, cars, munching, creaking chairs, breathing, copy machines, babies crying, dogs barking etc. Next, synthetic clips can be generated by mixing the raw input signals with the noise clips.

A training data set for training a quality estimation model can be provided with (1) synthetic clips with added noise, (2) synthetic clips with added noise and added reverb, and (3) real recordings where noise and/or reverberations occur in the raw input signals, e.g., the original recordings. These “naturally” noisy and/or reverberant clips can be helpful because the noise/reverberations are captured with the same acoustic conditions, and with the same microphone, as the original speech. Thus, the synthetic clips generally allow the quality estimation model to be trained with different types of noise that may not be adequately represented in the real recordings, whereas the real recordings allow the quality estimation model to be trained with noisy and/or reverberant examples where the noise and reverberation are captured under the same conditions as the speech itself.

### Example Training Data Flow for Quality Estimation Model

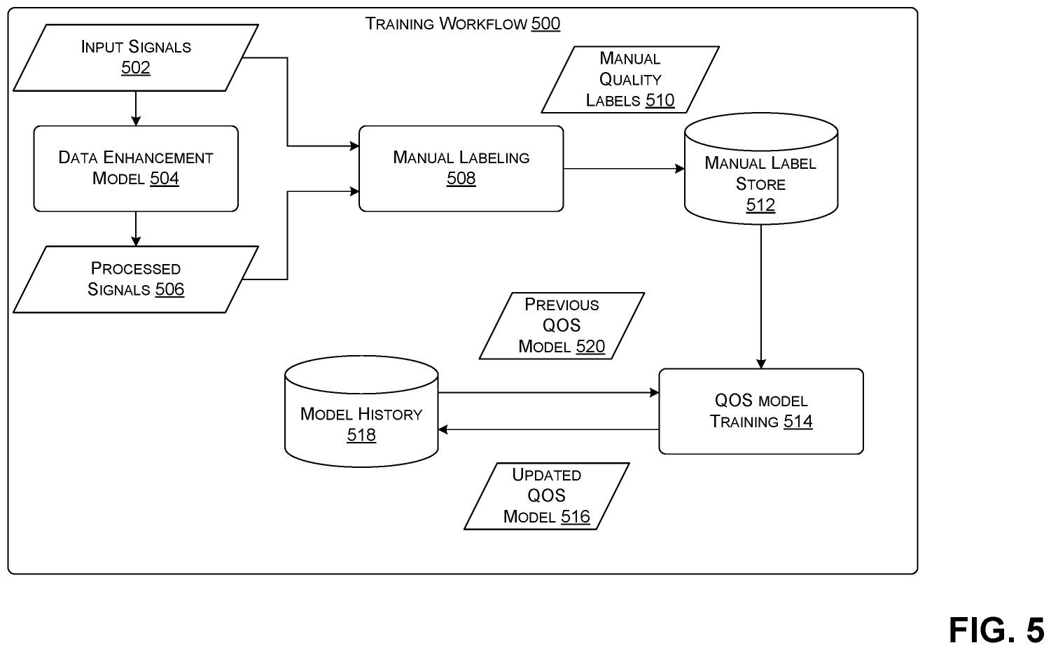

FIG. 5 illustrates an example training workflow 500 for training a quality estimation model, consistent with some implementations of the present concepts.

Input signals 502 are input to a data enhancement model 504. The data enhancement model produces processed signals 506. Manual labeling 508 is performed on the input signals and/or processed signals (potentially with reference to the input signals) to obtain manual quality labels 510, which convey the perceived quality of the input signals or the processed signals produced by the data enhancement model. The manual quality labels are used to populate a manual label store 512.

Quality of service (QOS) model training 514 proceeds using the manual quality labels 510 in the manual label store 512. Multiple iterations of training can be performed, with internal parameters of the quality of service model being adapted at each iteration to obtain an updated quality of service model 516, which is then output to a model history 518. The next training iteration can proceed by retrieving the previous quality of service model 520 from the model history and continuing with training iterations.

Training workflow 500 can be performed for multiple iterations using training signals, including the input signals 502 and/or processed signals produced by multiple data enhancement models. In some cases, quality of service model training 514 is performed until a stopping condition is reached, e.g., the quality of service model converges, the quality of service model achieves a threshold accuracy on a test data set, a training budget is exhausted, and/or all the examples in the manual label store 512 have been exhausted.

When training workflow 500 is performed on training examples for subsequent data enhancement models, in some cases the same input signals 502 are employed. However, different data enhancement models will output different processed signals 506 and the different processed signals will often have different manual quality labels assigned by users.

### Example Data Enhancement Models

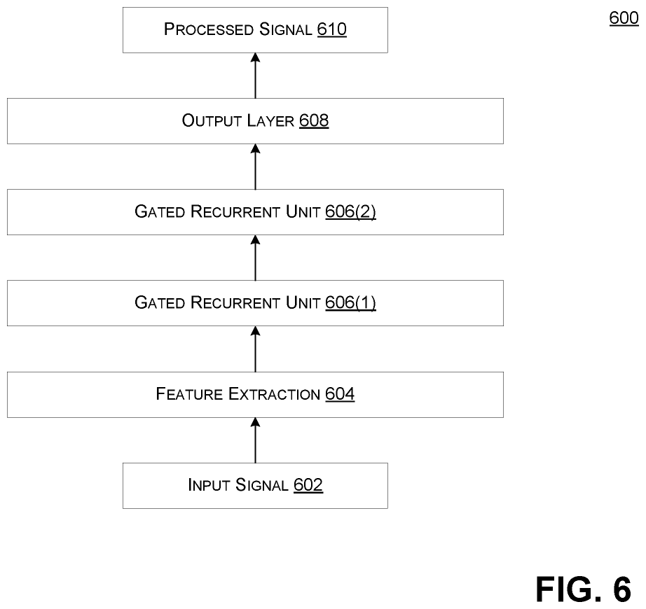

FIG. 6 illustrates an example data enhancement model 600, consistent with some implementations of the present concepts. An input signal 602 is input to feature extraction 604, where features are extracted. In the case of an audio signal, the features can include short-term Fourier features, log-power spectral features, and/or log power Mel spectral features can be extracted. A gated recurrent unit 606(1) can process the extracted features and provide output to another gated recurrent unit 606(2). The output of gated recurrent unit 606(2) can be input to an output layer 608 that produces a processed signal 610.

As noted previously, a data enhancement model can be trained using synthetic labels as described herein, e.g., to adjust internal model parameters. In some cases, data enhancement models can be adapted in other ways, e.g., by changing the architecture of the model.

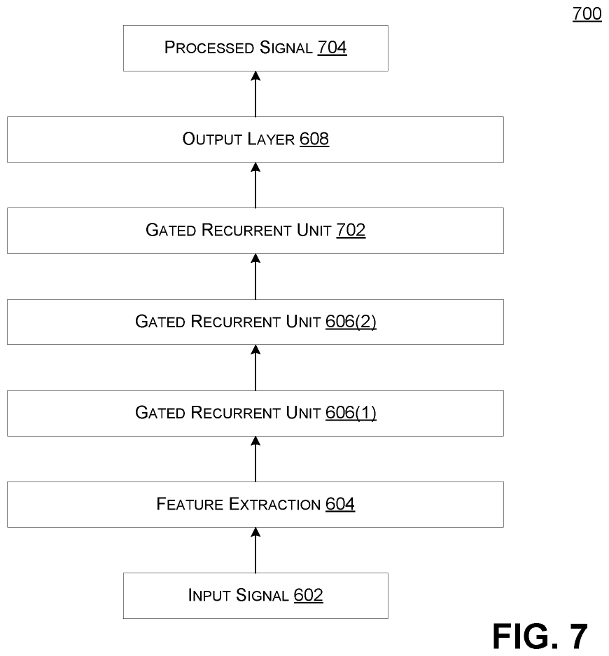

FIG. 7 illustrates an example adapted data enhancement model 700, consistent with some implementations of the present concepts. The adapted data enhancement model is similar to data enhancement model 600, with the addition of a new gated recurrent unit 702 and processed signal 704, to convey that the adapted data enhancement model can produce a different processed signal than data enhancement model 600 given the same input signal. Note that adding a specific layer such as gated recurrent unit 702 is just one example of many different architectural changes that can be performed. For instance, some implementations may add or remove recurrent layers, convolutional layers, pooling layers, etc.

### Example Enhancement Model Adaptation Workflow

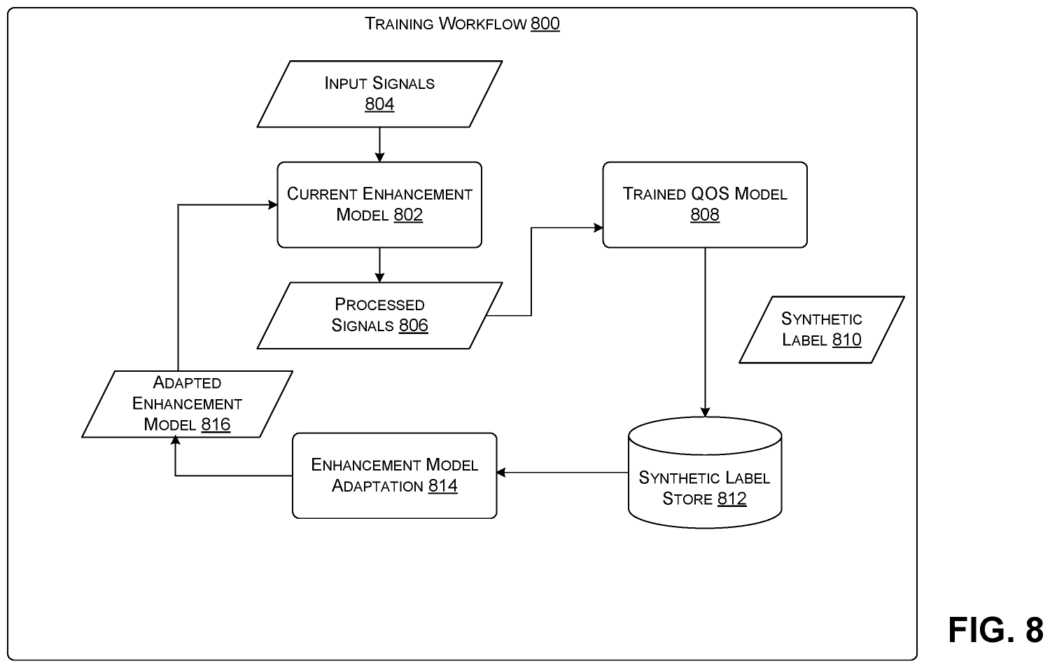

FIG. 8 illustrates an example training workflow 800 for training a quality estimation model, consistent with some implementations of the present concepts.

A current enhancement model 802 is used to process input signals 804. The current enhancement model produces processed signals 806. The processed signals are input to a trained quality of service model 808, which produces synthetic labels 810. The synthetic labels are stored in a synthetic label store 812. An enhancement model adaptation process 814 is performed on the current enhancement model to obtain an adapted enhancement model 816. The adapted enhancement model can be used as the current enhancement model for the next iteration of model adaptation.

As previously noted, enhancement model adaptation can involve adjusting internal parameters, such as neural network weights and bias values. In such implementations, a loss function can be defined over the values of the synthetic labels 810, where lower quality values for the synthetic labels imply greater loss values. The calculated loss values can be back-propagated through the data enhancement model to adjust the internal parameters.

Enhancement model adaptation can also involve architectural changes. For instance, an initial pool of candidate data enhancement model structures can be defined, where each candidate model structure has a specified number and type of layers, connectivity, activation functions, etc. Individual candidate model structures can be trained using training workflow 800, and relatively high-performing candidate model structures can be retained for modification, where a “high-performing” candidate model structure implies relatively higher average synthetic quality labels for processed signals produced using that model structure. Next, these high-performing candidate model structures can be modified, e.g., by adding layers, removing layers, changing the type of individual layers, the number of hidden layers, changing layer connectivity or activation functions, and so on to obtain a new pool of candidate model structures. This process can be repeated several times until a final candidate model is selected and trained using synthetic labels as described above.

Note that enhancement model adaptation can also involve selection of hyperparameters such as learning rates, batch sizes, numbers of training epochs, etc. In some cases, the same enhancement model structure can be trained with synthetic quality labels using different learning rates and/or batch sizes, resulting in multiple enhancement models sharing structure but having different internal parameters. The enhancement model having the best overall average synthetic quality label can selected as a final enhancement model.

### Example User Experience

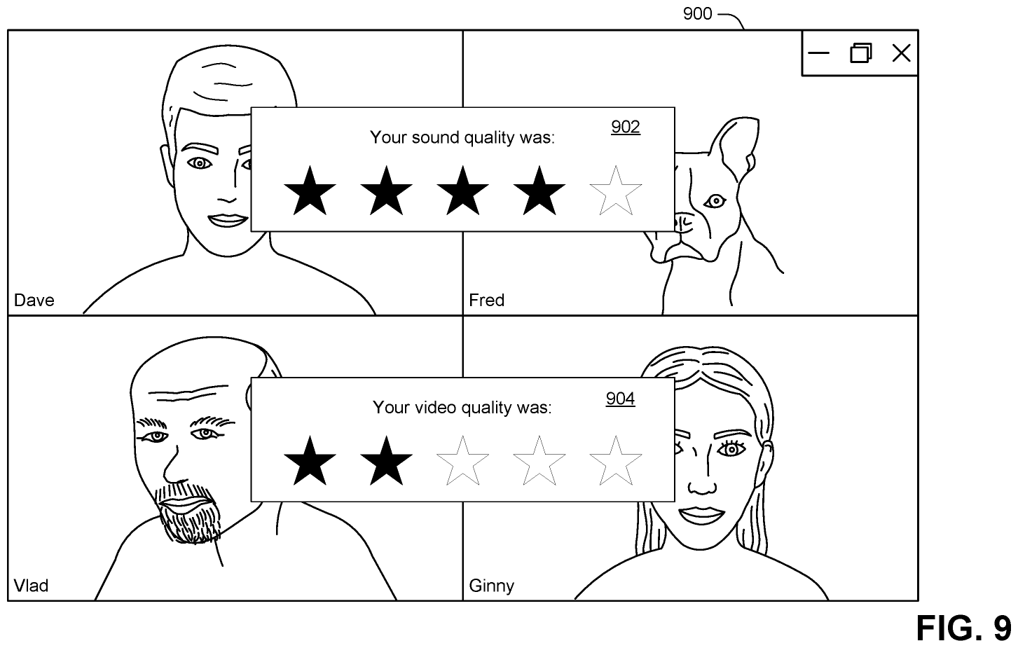

Quality estimation models such as those disclosed herein can also be employed for real-time estimation of signal quality. FIG. 9 illustrates a video call GUI 900 that can be populated with information obtained from a quality estimation model trained as disclosed herein. Video call GUI 900 includes a sound quality estimate 902 that conveys a value of four stars out of five for the audio signal of a video call. Video call GUI 900 also includes a video quality estimate 904 that conveys a value of two stars out of five for the video signal of the video call.

In some cases, video call GUI 900 can include an option for the user to confirm or modify the audio or video quality ratings. The user input can be used to manually label audio or video content of the call for subsequent training and/or tuning of a quality estimation model.

### Device Implementations

As noted above with respect to FIG. 1, system 100 includes several devices, including a client device 110, a server 120, a server 130, and a server 140. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 150. Without limitation, network(s) 150 can include one or more local area networks (LANs), wide area networks (WANs), the Internet, and the like.

Various examples are described above. Additional examples are described below. One example includes a method comprising obtaining training signals exhibiting diverse impairments introduced when the training signals are captured or diverse artifacts introduced by different processing characteristics of a plurality of data enhancement models, obtaining quality labels for the training signals, and training a quality estimation model to estimate signal quality based at least on the training signals and the quality labels.

Another example can include any of the above and/or below examples where the training signals comprise audio signals.

Another example can include any of the above and/or below examples where the training signals comprise speech data.

Another example can include any of the above and/or below examples where the training signals comprise processed signals output by a plurality of data enhancement models comprising at least one of noise removal models, echo removal models, distortion removal models, codecs, or models for addressing quality degradation caused by room response, network loss/jitter issues, or device distortion.

Another example can include any of the above and/or below examples where the training signals comprise image or video data

Another example can include any of the above and/or below examples where the training signals comprise processed signals output by a plurality of data enhancement models comprising at least one of image/video healing models, low light enhancement models, image/video sharpening models, image/video denoising models, codecs, or models for addressing quality degradation caused by color balance issues, veiling glare issues, low contrast issues, flickering issues, low dynamic range issues, camera jitter issues, frame drop issues, frame jitter issues, and/or audio video synchronization issues.

Another example can include any of the above and/or below examples where the quality estimation model comprises a deep neural network

Another example can include any of the above and/or below examples where the quality labels characterize quality of processed training signals output by the plurality of data enhancement models without reference to input signals processed by the plurality of data enhancement models to obtain the processed training signals.

Another example can include any of the above and/or below examples where the training signals include at least one of recording device impairments introduced by recording devices that capture the training signals or capture condition impairments introduced by conditions under which the training signals are captured.

Another example can include any of the above and/or below examples where the quality estimation model is trained without access to an unimpaired reference signal.

Another example can include any of the above and/or below examples where the method further comprises providing an overall quality estimation model using the quality estimation model and another quality estimation model trained on other training signals exhibiting different impairments.

Another example can include any of the above and/or below examples where the method further comprises selecting the plurality of data enhancement models to train the quality estimation model based at least on individual types of artifacts introduced by multiple candidate data enhancement models.

Another example includes a system comprising a processor and a storage medium storing instructions which, when executed by the processor, cause the system to access a quality estimation model that has been trained to estimate signal quality using training signals exhibiting diverse impairments introduced when the training signals were captured or diverse artifacts introduced by a plurality of data enhancement models, provide an input signal to the quality estimation model, and process the input signal with the quality estimation model to obtain a synthetic quality label for the input signal.

Another example can include any of the above and/or below examples where the input signal is produced by another data enhancement model and the instructions, when executed by the processor, cause the system to modify the another data enhancement model based at least on the synthetic quality label.

Another example can include any of the above and/or below examples where the another data enhancement model comprises a particular data enhancement machine learning model.

Another example can include any of the above and/or below examples where the instructions, when executed by the processor, cause the system to modify the particular data enhancement machine learning model by adjusting at least one of hyperparameters, internal parameters, or a structure of the particular data enhancement machine learning model.

Another example can include any of the above and/or below examples where the input signal comprises audio data and the another data enhancement model is configured as at least one of a noise removal model, an echo removal model, a distortion removal model, a codec, or a model for addressing quality degradation caused by room response, or network loss/jitter.

Another example can include any of the above and/or below examples where the input signal comprises image or video data and the another data enhancement model is configured as at least one of an image/video healing model, a low light enhancement model, an image/video sharpening model, an image/video denoising model, a codec, or a model for addressing quality degradation caused by color balance issues, veiling glare issues, low contrast issues, flickering issues, low dynamic range issues, camera jitter issues, frame drop issues, frame jitter issues, and/or audio video synchronization issues.

Another example can include any of the above and/or below examples where the instructions, when executed by the processor, cause the system to rank a plurality of other data enhancement models based at least on synthetic quality labels output by the quality estimation model.

Another example includes a computer-readable storage medium storing instructions which, when executed by a computing device, cause the computing device to perform acts comprising obtaining training signals exhibiting at least one of diverse impairments introduced when the training signals are captured or diverse artifacts introduced by different processing characteristics of a plurality of data enhancement models, obtaining quality labels for the training signals, and training a quality estimation model to estimate signal quality based at least on the quality labels.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
obtaining training signals exhibiting diverse impairments introduced when the training signals are captured or diverse artifacts introduced by different processing characteristics of a plurality of data enhancement models;
obtaining quality labels for the training signals; and
training a quality estimation model to estimate signal quality based at least on the training signals and the quality labels.

2. The method of claim 1, the training signals comprising audio signals.

3. The method of claim 2, the training signals comprising speech data.

4. The method of claim 2, wherein the training signals comprise processed signals output by a plurality of data enhancement models comprising at least one of noise removal models, echo removal models, distortion removal models, codecs, or models for addressing quality degradation caused by room response, network loss/jitter issues, or device distortion.

5. The method of claim 1, the training signals comprising image or video data.

6. The method of claim 5, wherein the training signals comprise processed signals output by a plurality of data enhancement models comprising at least one of image/video healing models, low light enhancement models, image/video sharpening models, image/video denoising models, codecs, or models for addressing quality degradation caused by color balance issues, veiling glare issues, low contrast issues, flickering issues, low dynamic range issues, camera jitter issues, frame drop issues, frame jitter issues, and/or audio video synchronization issues.

7. The method of claim 1, the quality estimation model comprising a deep neural network.

8. The method of claim 1, wherein the quality labels characterize quality of processed training signals output by the plurality of data enhancement models without reference to input signals processed by the plurality of data enhancement models to obtain the processed training signals.

9. The method of claim 1, wherein the training signals include at least one of recording device impairments introduced by recording devices that capture the training signals or capture condition impairments introduced by conditions under which the training signals are captured.

10. The method of claim 1, wherein the quality estimation model is trained without access to an unimpaired reference signal.

11. The method of claim 1, further comprising:
providing an overall quality estimation model using the quality estimation model and another quality estimation model trained on other training signals exhibiting different impairments.

12. The method of claim 1, further comprising:
selecting the plurality of data enhancement models to train the quality estimation model based at least on individual types of artifacts introduced by multiple candidate data enhancement models.

13. A system comprising:
a processor; and
a storage medium storing instructions which, when executed by the processor, cause the system to:
access a quality estimation model that has been trained to estimate signal quality using training signals exhibiting diverse impairments introduced when the training signals were captured or diverse artifacts introduced by a plurality of data enhancement models;
provide an input signal to the quality estimation model; and
process the input signal with the quality estimation model to obtain a synthetic quality label for the input signal.

14. The system of claim 13, wherein the input signal is produced by another data enhancement model and the instructions, when executed by the processor, cause the system to:
modify the another data enhancement model based at least on the synthetic quality label.

15. The system of claim 14, the another data enhancement model comprising a particular data enhancement machine learning model.

16. The system of claim 15, wherein the instructions, when executed by the processor, cause the system to:
modify the particular data enhancement machine learning model by adjusting at least one of hyperparameters, internal parameters, or a structure of the particular data enhancement machine learning model.

17. The system of claim 14, wherein the input signal comprises audio data and the another data enhancement model is configured as at least one of a noise removal model, an echo removal model, a distortion removal model, a codec, or a model for addressing quality degradation caused by room response, or network loss/jitter.

18. The system of claim 14, wherein the input signal comprises image or video data and the another data enhancement model is configured as at least one of an image/video healing model, a low light enhancement model, an image/video sharpening model, an image/video denoising model, a codec, or a model for addressing quality degradation caused by color balance issues, veiling glare issues, low contrast issues, flickering issues, low dynamic range issues, camera jitter issues, frame drop issues, frame jitter issues, and/or audio video synchronization issues.

19. The system of claim 13, wherein the instructions, when executed by the processor, cause the system to:
rank a plurality of other data enhancement models based at least on synthetic quality labels output by the quality estimation model.

20. A computer-readable storage medium storing instructions which, when executed by a computing device, cause the computing device to perform acts comprising:
obtaining training signals exhibiting at least one of diverse impairments introduced when the training signals are captured or diverse artifacts introduced by different processing characteristics of a plurality of data enhancement models;
obtaining quality labels for the training signals; and
training a quality estimation model to estimate signal quality based at least on the quality labels.
